(19) United States
(12) Patent Application Publication
(10) Pub. No.: US 2018/0133630 A1
(43) Pub. Date: May 17, 2018

(54) BATH SHOWER WITH DISPOSABLE FILTRATION UNIT

(71) Applicant: NEP HOLDINGS (MAYLAYSIA) BHD, Seri Kembangan (MY)

(72) Inventor: Lim Chang HUAT, Seri Kembangan (MY)

(73) Assignee: NEP HOLDINGS (MAYLAYSIA) BHD, Seri Kembangan (MY)

(21) Appl. No.: 15/871,410

(22) Filed: Jan. 15, 2018

Related U.S. Application Data
(63) Continuation-in-part of application No. 15/349,321, filed on Nov. 11, 2016.

(51) Int. Cl. B01D 35/04; E03C 1/02; E03C 1/04; C02F 1/00; C02F 1/48; B01D 35/027; B01D 27/04; B01D 27/14; B01D 29/56; B01D 35/06

(52) U.S. Cl. CPC B01D 35/04; E03C 1/025; E03C 1/0409; C02F 1/001; C02F 1/005; C02F 2103/02; B01D 35/027; B01D 27/04; B01D 27/146; B01D 29/56; B01D 35/06; C02F 1/48

(57) ABSTRACT

The present invention provides a water shower filter unit to provide clean treated water substantially free from chlorine, organic contaminants, and suspended solids by the use of primary filter, secondary filter and tertiary filter. The primary filter constructed from polymer material capable of filtering particle of 10 microns and above for eliminating suspended solid. The primary filter further comprises of chlorine removal material for removal of chlorine and contaminants. The secondary filter made of multiple layers of activated balls. Tertiary filter made of magnetic energy ceramics balls and mineral stones reside in elongated, hollow internal chamber of shower head is for water activation.

### CROSS-REFERENCE

This patent application is a continuation-in-part of U.S. application Ser. No. 15/349,321 filed Nov. 11, 2016, which is incorporated herein by reference.

### FIELD OF INVENTION

The present invention relates to a bath shower unit with disposable filtration unit.

### BACKGROUND OF ART

Municipal water usually contains particles such as excessive chlorine, mud, clay, soil particle and rusty water is conveyed using steel pipes. Untreated water supplies are being polluted by contaminants may result merely in an unpleasant odour or taste in the water or may cause severe consequences such as eyes irritation, skin rashes, and hair damage. Therefore, water filter is used to purify the water and provide safer and raise the quality of the water supply.

One example of shower water filter is disclosed in the U.S. Pat. No. 6,016,977 (US 977 Patent) entitled “Hand Held Shower Head and Filter Housing” having a filing date of 29 Jul. 1998 (Applicant: David K. Farley) disclosed a hand held shower head and filter assembly using non-soluble calcium sulfite for filtering contaminants from hot water passing there through at high flow rates. As disclosed in the US 977 Patent, the hand held shower head and filter having an elongated, hollow handle. The filter element of the US 977 Patent may have a filter media, such as non-soluble calcium sulphite, alone or combined with a copper-zinc medium therein.

Another example of shower water filter is disclosed in the U.S. Pat. No. 6,537,455 (US 455 Patent) entitled “Elongated Hand-held Shower Head and Filter” having a grant date of 25 Mar. 2003 (Applicant: David K. Farley) disclosed a combination of hand held shower head and water filter assembly for filtering contaminants from hot water passing there through at high flow rates. It is further provided in the US 455 Patent to provide an improved elongated combination hand held shower head and water filter having a swivel shower head attached to an elongated in line hose filter that is sized and dimensioned to it into a holding bracket in two positions.

A further example of shower water filter is disclosed in the U.S. Pat. No. 6,096,197 (US 197 Patent) entitled “Shower Filter For Chlorine Removal and Scale Deposit Prevention” having a filing date of 11 Dec. 1997 (Applicant: Douglas E. Hughes) disclosed dual-purpose shower and bath filter to reduce chlorine in shower water through absorption, reduce or eliminate scale deposits. The filter unit enables a single device to simultaneously prevent scale deposits from forming on plumbing and wall surfaces while also reducing or eliminating the chlorine from shower spray. It is further disclosed in US 197 Patent that the filter cartridge accomplishes the scale reduction or prevention by treating water with a specially designed phosphate that coats scale (comprising calcium and magnesium) so that it will not stick to plumbing or wall surfaces. Further, the filter cartridge accomplishes the reduction or elimination of chlorine in the water through the absorption capabilities of a superfine mesh powdered activated carbon, formed into a carbon block.

It is the general object of the invention to provide an improved water shower filter unit that effectively removes chlorine, organic contaminants and suspended solid from shower water through multi-layer filter which can further enhance the water quality during bathing and showering.

### SUMMARY OF INVENTION

The present invention relates to a water shower unit with disposable filtration unit.

One aspect of the invention is to provide a water shower filter unit having at least one water storage tank; a shower head; a first flexible hose having a first end connected to a water inlet of a first water storage tank; a second flexible hose having a first end connected to a water outlet of a second water storage tank and a second end connected to the shower head. The at least one water storage tank comprises a primary filter mounted within the first water storage tank and a secondary filter embedded within the second water storage tank.

Another aspect of the invention is to provide a primary filter is constructed from polymer material of high density fabric which includes FILTRON™.

A further aspect of the invention is to provide the polymer material is able to filter particle of 10 microns and above.

Another aspect of the present invention is to provide the primary filter is disposable.

Another aspect of the invention is to provide the primary filter comprises chlorine removal material to remove chlorine and contaminants from a water source.

Another aspect of the invention is to provide the shower head is affixed with a hollow filter handle having elongated internal chamber for holding a tertiary filter.

A further aspect of the invention is to provide the tertiary filter is embedded within the elongated internal chamber of the hollow filter handle.

Yet another aspect of the invention is to provide the tertiary filter is made of magnetic energy ceramics balls and mineral stones.

Another aspect of the invention provides that the shower head is hand held.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE ACCOMPANYING DRAWING

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings.

FIG. 1 illustrates the exploded perspective view of the shower water filter unit.

### DETAILED DESCRIPTION OF THE PREFERRED EMBODIMENTS

The present invention relates to a water shower unit with disposable filtration unit. Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

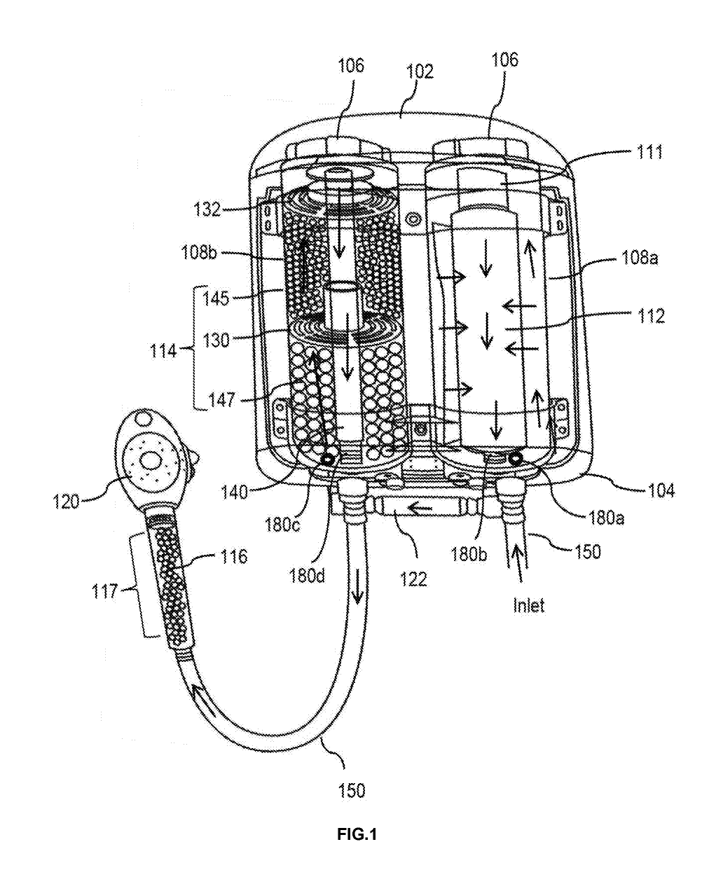

FIG. 1 illustrates a water shower filter unit of the present invention. As illustrated in FIG. 1, the water shower filter unit comprises a housing (104), a water storage tank (108a, 108b) having a water inlet and a water outlet, a shower head (120); a first flexible hose having a first end connected to a water inlet (180a) of a first water storage tank (108a); a second flexible hose having a first end connected to a water outlet (180d) of a second water storage tank (108b) and a second end connected to the shower head (120). The water storage tank (108a, 108b) comprises a primary filter (112) and a secondary filter (114).

The housing (104) of the water shower filter unit having a cover (102) and an interior space for enclosing at least one water storage tanks (108a, 108b).

The water storage tanks (108a, 108b) comprises a first water storage tank (108a) and a second water storage tank (108b) whereby each of the water storage tank having a water inlet (180a, 180c) and a water outlet (180b, 180d) at bottom of the water storage tank. Each of the water storage tanks (108a, 108b) includes a tank cover (106). The first water storage tank (108a) having a water inlet (180a) which is connected to a flexible hose (150) for receiving incoming water from the water source (i.e. municipal water) and a water outlet (180b) connected to a central pipe of a primary filter's holder (111) to allow filtered water to flow to a water inlet (180c) of the second water storage tank (108b) through a coupling member (122). A water outlet (180d) of the second water storage tank is connected to a central pipe (140) whereby a first end of a flexible hose is connected to the water outlet (180d) of the second water storage tank and a second end of a flexible hose is connected to a hollow filter handle (117) of a shower head.

The shower head (120) may be constructed in any conventional or known manner from any acceptable material, such as a high strength plastic or the like. The shower head (120) is affixed to a hollow filter handle (117) having elongated internal chamber to hold a tertiary filter (116). The hollow filter handle (117) may be used as a handle for grasping or holding the shower head (120). The first end of a flexible hose (150) connected to the water outlet (180d) of the second water storage tank (108) and the second end of the flexible hose connected to the hollow filter handle (117) of a shower head.

The first stage of filtration is the primary filter (112). The primary filter (112) is mounted within the first water storage tank (108a). The primary filter (112) is made of disposable polymer material preferably high density fabric (143) which includes FILTRON™ whereby the filtration medium wrapped around a filter holder (111). The filter holder (111) having a central pipe which allows overflow of filtered water to flow to the water inlet (180c) of the second water storage tank (108b). The central pipe comprises of chlorine removal material to remove residual chlorine and contaminants from the municipal water source and supply. Preferably, the polymer material of the primary filter may be selected from the group consisting of Polyester, Polyethylene (PE), Polypropylene (PP) or high density fabric (i.e. FILTRON™) due to its ability to remove suspended solid, rust and filter off particles of 10 microns and above. FILTRON™ filter fabric is a high density-type fabric with small pore size of 10 microns and air permeability rate of ˜20%. Other filtration medium that can achieve this can also be used instead.

The second stage of filtration is the secondary filter (114). The secondary filter (114) comprises of multiple layers of activated balls (145, 147) arranged within a second storage tank (108b), whereby the multiple layers of balls are divided by a spacer (130). An end cap (132) is affixed to a top portion of a central pipe (140) to prevent the activated balls from flowing into the central pipe during the filtration process. The balls are energy balls preferably made of ceramic (145, 147) with the presence of ceramic mineral which emits a large amount of anions and far-infrared rays. The energy balls can treat water to produce smaller water cluster, removes bad odors, and increases dissolved oxygen in water.

The third stage of filtration is the tertiary filter. The tertiary filter (116) contains magnetic energy ceramics balls and mineral stones held in elongated cylindrical filter cartridge which is aligned to be coaxial with longitudinal axis of the hollow filter handle (117). The magnetic energy ceramic balls are made of mineral materials (i.e. ferrite) and other functional materials such as silicon nitride and zirconium dioxide through high temperature sintering which combines with a permanent magnetic particulate. The magnetic energy ceramics balls and mineral stones of the tertiary filter (116) activates the water molecules in such a way that the water changes to magnetized water upon flowing through the magnetic energy ceramic balls results in changes of physical and chemical properties of water due to electromagnetic induction in the magnetic field. The water molecules that undergo activation treatment by magnetic field or bio-ceramic stones will transform into smaller clusters of water molecules. Such water molecules can easily absorb by the human body and magnetized water may activate certain enzyme activity.

In use, the water flows from the water inlet (180a) at the bottom of the first water storage tank (108a) and subsequently the water flows upwards through the primary filter (112) for removal of chlorine and suspended solid. The filtered water is then overflows within the first water storage tank (108a) causing the filtered water to flow down through the central pipe of the primary filter's holder which is connected to the water inlet (180c) of the second water storage tank (108b) through a coupling member (122). Next, the filtered water flows upward through multiple layers of activated balls of the secondary filter (114). The overflow of filtered water within the second water storage tank (108b) directs the filtered water to flow downwards through the central pipe (140) to a water outlet (180d) at the bottom of the second water storage tank (108b). The filtered water is flowed through the flexible hose (150) for further filtration by tertiary filter (116) which is embedded within the hollow filter handle (117) before exiting through the shower head (120).

The present embodiments are considered as merely illustrative and not restrictive, the description to the preferred embodiments of the invention is merely to facilitate discussion of the present invention and it is envisioned without departing from the scope of the appended claims.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

1. A water shower filter unit having:
at least one water storage tank;
a shower head;
a first flexible hose having a first end connected to a water inlet of a first water storage tank; a second flexible hose having a first end connected to a water outlet of a second water storage tank and a second end connected to the shower head; characterized in that
the at least one water storage tank further comprises:
a primary filter mounted within the first water storage tank; and
a secondary filter embedded within the second water storage tank.

2. The water shower filter unit according to claim 1, wherein the primary filter is constructed from polymer material of high density fabric which includes FILTRON™.

3. The water shower filter unit according to claim 1, wherein the polymer material is able to filter particle of 10 microns and above.

4. The water shower filter unit according to claim 2 wherein the primary filter is disposable.

5. The water shower filter unit according to claim 1, wherein the primary filter comprises chlorine removal material to remove chlorine and contaminants from a water source.

6. The water shower filter unit according to claim 1, wherein the shower head is affixed with a hollow filter handle having elongated internal chamber for holding a tertiary filter.

7. The water shower filter unit according to claim 6, wherein the tertiary filter is embedded within the elongated internal chamber of the hollow filter handle.

8. The water shower filter unit according to claim 6, wherein the tertiary filter is made of magnetic energy ceramics balls and mineral stones.

9. The water shower filter unit according to claim 6, wherein the shower head is hand held.
